(19) United States
(12) Patent Application Publication
(10) Pub. No.: US 2024/0087039 A1
(43) Pub. Date: Mar. 14, 2024

(54) COMPREHENSIVE LIABILITY MANAGEMENT PLATFORM WITH INTEGRATION WITH PROVIDER NETWORKS AND PROVIDER NEGOTIATIONS SYSTEMS

(71) Applicant: Mitchell International, Inc., San Diego, CA (US)

(72) Inventors: Norman Tyrrell, San Diego, CA (US); Christopher Williamson, San Diego, CA (US); Lee Haripko, San Diego, CA (US)

(73) Assignee: Mitchell International, Inc., San Diego, CA (US)

(21) Appl. No.: 18/231,932

(22) Filed: Aug. 9, 2023

Related U.S. Application Data
(60) Provisional application No. 63/405,701, filed on Sep. 12, 2022.

(51) Int. Cl. G06Q 40/08

(52) U.S. Cl. CPC G06Q 40/08

(57) ABSTRACT

A computer-implemented method comprises: receiving, from an insurer system, an electronic medical bill; generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow, and routing the electronic medical bill accordingly.

### CROSS REFERENCE TO RELATED APPLICATIONS

The present application claims priority to U.S. Provisional Patent Application No. 63/405,701, filed Sep. 12, 2022, entitled “COMPREHENSIVE THIRD PARTY LIABILITY MANAGEMENT PLATFORM WITH INTEGRATION WITH PROVIDER NETWORKS AND PROVIDER NEGOTIATIONS SYSTEMS,” the disclosure thereof incorporated by reference herein in its entirety.

### DESCRIPTION OF RELATED ART

The disclosed technology relates generally to liability management platforms, and more particularly some embodiments relate to integration of such platforms with other systems.

### SUMMARY

In general, one aspect disclosed features a management platform for adjusting one or more electronic medical bills for a claimant injured in an accident, comprising: one or more hardware processors; and one or more non-transitory machine-readable storage media encoded with instructions executable by the one or more hardware processors to perform operations comprising: receiving, from an insurer system of an insurer, an electronic medical bill representing medical services provided by a provider; generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow, responsive to generating a decision representing the provider network workflow: routing the electronic medical bill to a provider network system, wherein the provider network system adjusts the electronic medical bill by adjusting one or more payment amounts in the electronic medical bill according to agreed-upon network rates, receiving, from the provider network system, the adjusted electronic medical bill, and transmitting the adjusted electronic medical bill to the insurer system.

Embodiments of the platform may include one or more of the following features. In some embodiments, the operations further comprise, responsive to generating a decision representing the provider negotiations workflow: routing the electronic medical bill to a provider negotiations process, wherein the provider negotiations process adjusts the electronic medical bill by adjusting one or more payment amounts in the electronic medical bill; receiving, from the provider negotiations system, the adjusted electronic medical bill; and transmitting the adjusted electronic medical bill to the insurer system. In some embodiments, the operations further comprise, prior to generating a decision representing a workflow: retrieving, from a rules database, one or more rules established by the insurer; and adjusting the electronic medical bill according to the one or more rules.

In some embodiments, the plurality of decisioning factors comprise at least one of: a dollar value of charges in the electronic medical bill; insurance policy coverage of the claimant; expected turnaround time for processing the electronic medical bill; and historical rates of success in provider negotiations for a type of electronic medical bill. In some embodiments, the operations further comprise: obtaining a training data set comprising the historical electronic medical bills and corresponding historical decisions; and training the machine learning model using the training data set. In some embodiments, the operations further comprise: generating the training data set. In some embodiments, the operations further comprise: determining whether the electronic medical bill is eligible for further processing; and generating a decision representing a workflow only responsive to determining the electronic medical bill is eligible for further processing.

In general, one aspect disclosed features one or more non-transitory machine-readable storage media encoded with instructions executable by the one or more hardware processors to perform operations for adjusting one or more electronic medical bills for a claimant injured in an accident, the operations comprising: receiving, from an insurer system of an insurer, an electronic medical bill representing medical services provided by a provider; generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow, responsive to generating a decision representing the provider network workflow: routing the electronic medical bill to a provider network system, wherein the provider network system adjusts the electronic medical bill by adjusting one or more payment amounts in the electronic medical bill according to agreed-upon network rates, receiving, from the provider network system, the adjusted electronic medical bill, and transmitting the adjusted electronic medical bill to the insurer system.

Embodiments of the media may include one or more of the following features. of claim 8, the operations further comprising, responsive to generating a decision representing the provider negotiations workflow: routing the electronic medical bill to a provider negotiations process, wherein the provider negotiations process adjusts the electronic medical bill by adjusting one or more payment amounts in the electronic medical bill; receiving, from the provider negotiations system, the adjusted electronic medical bill; and transmitting the adjusted electronic medical bill to the insurer system. In some embodiments, the operations further comprise, prior to generating a decision representing a workflow: retrieving, from a rules database, one or more rules established by the insurer; and adjusting the electronic medical bill according to the one or more rules.

In some embodiments, the plurality of decisioning factors comprise at least one of: a dollar value of charges in the electronic medical bill; insurance policy coverage of the claimant; expected turnaround time for processing the electronic medical bill; and historical rates of success in provider negotiations for a type of electronic medical bill. In some embodiments, the operations further comprise: obtaining a training data set comprising the historical electronic medical bills and corresponding historical decisions; and training the machine learning model using the training data set. In some embodiments, the operations further comprise: generating the training data set. In some embodiments, the operations further comprise: determining whether the electronic medical bill is eligible for further processing; and generating a decision representing a workflow only responsive to determining the electronic medical bill is eligible for further processing.

In general, one aspect disclosed features a computer-implemented method for adjusting one or more electronic medical bills for a claimant injured in an accident, the operations comprising: receiving, from an insurer system of an insurer, an electronic medical bill representing medical services provided by a provider; generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow, responsive to generating a decision representing the provider network workflow: routing the electronic medical bill to a provider network system, wherein the provider network system adjusts the electronic medical bill by adjusting one or more payment amounts in the electronic medical bill according to agreed-upon network rates, receiving, from the provider network system, the adjusted electronic medical bill, and transmitting the adjusted electronic medical bill to the insurer system.

Embodiments of the method may include one or more of the following features. In some embodiments, the operations further comprise, responsive to generating a decision representing the provider negotiations workflow: routing the electronic medical bill to a provider negotiations process, wherein the provider negotiations process adjusts the electronic medical bill by adjusting one or more payment amounts in the electronic medical bill; receiving, from the provider negotiations system, the adjusted electronic medical bill; and transmitting the adjusted electronic medical bill to the insurer system. In some embodiments, the operations further comprise, prior to generating a decision representing a workflow: retrieving, from a rules database, one or more rules established by the insurer; and adjusting the electronic medical bill according to the one or more rules.

In some embodiments, the plurality of decisioning factors comprise at least one of: a dollar value of charges in the electronic medical bill; insurance policy coverage of the claimant; expected turnaround time for processing the electronic medical bill; and historical rates of success in provider negotiations for a type of electronic medical bill. In some embodiments, the operations further comprise: obtaining a training data set comprising the historical electronic medical bills and corresponding historical decisions; and training the machine learning model using the training data set. In some embodiments, the operations further comprise: generating the training data set.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a comprehensive liability management platform with integration with provider networks and provider negotiations systems according to some embodiments of the disclosed technology.

FIG. 2 illustrates a process for an incident reporting workflow according to some embodiments of the disclosed technology.

FIG. 3 illustrates an example electronic medical bill as presented in a user interface of the 3P Liability Management Platform.

FIG. 4 illustrates a process for bill adjustment including integration with provider networks and provider negotiations systems according to some embodiments of the disclosed technology.

FIG. 5 is an example computing component that may be used to implement various features of embodiments described in the present disclosure.

The figures are not exhaustive and do not limit the present disclosure to the precise form disclosed.

### DETAILED DESCRIPTION

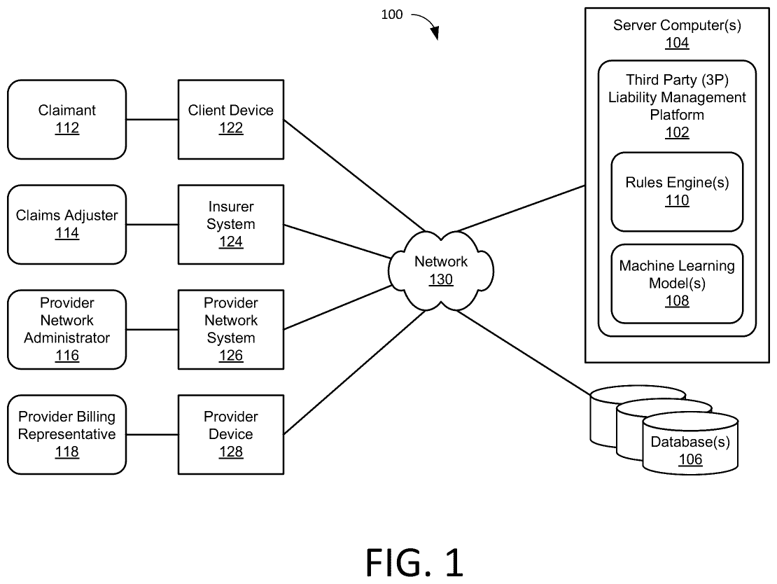

FIG. 1 illustrates a comprehensive third-party liability management platform with integration with provider networks and provider negotiations systems 100 according to some embodiments of the disclosed technology. The system 100 may include a Third-party (3P) Liability Management Platform 102. The 3P Liability Management Platform 102 may be implemented as one or more software packages executing on one or more server computers 104. The 3P Liability Management Platform 102 may include a rules engine 110 to execute one or more rules. The 3P Liability Management Platform 102 may include one or more machine learning models 108. The machine learning models 108 may be implemented in any manner. The machine learning models 108 may be implemented as trained machine learning models, for example as described below.

The system 100 may include one or more databases 106. In some embodiments, the databases 106 may store rules for execution by the rules engine 110 of the 3P Liability Management Platform 102. The rules may be different for each insurer using the 3P Liability Management Platform. In some embodiments, the databases 106 may store catalogues of pricing information. For example, the catalogues of pricing information may include pricing information established by provider networks such as agreed-upon network rates. In some embodiments, the databases 106 may store collateral source information. For example, the collateral source information may reflect prior payments made to the claimant or provider network.

Multiple users may interact with the 3P Liability Management Platform. For example, referring to FIG. 1, the users may include the claimant 112, a claims adjuster 114, a provider network administrator 116, a provider billing representative 118, and the like. Each user may employ a respective device or system. The claimant 112 may employ a client device 122. The claims adjuster 114 may employ an insurer system 124 of the insurer. The provider network administrator 116 may employ a provider network system 126. The provider billing representative 118 may employ a provider device 128. Each device or system may be implemented as a computer, smart phone, smart glasses, electronic embedded computers and displays, and the like. Each user may employ the client device or system to access the 3P Liability Management Platform 102 over a network 130 such as the Internet.

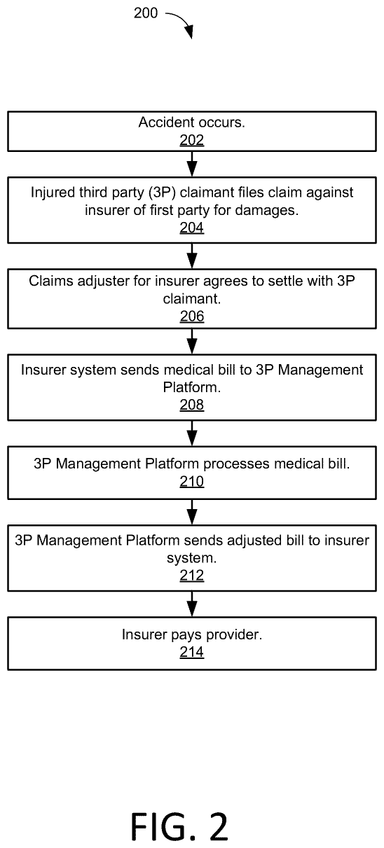

FIG. 2 illustrates a process 200 for an incident reporting workflow according to some embodiments of the disclosed technology. The elements of the disclosed processes are presented in a particular order. However, it should be understood that, in various embodiments, one or more elements may be performed in a different order, in parallel, or omitted. Portions of the process 200 may be performed, for example, by the 3P Liability Management Platform 102 of FIG. 1.

Referring again to FIG. 2, the process 200 may begin with an accident, at 202. In this disclosure, the accidents are described as vehicle accidents involving bodily injury. However, it should be understood that the disclosed technologies apply to other accidents as well.

The described examples include third-party claims. A third-party claim is a claim by a claimant against the insurance policy of another person. That claimant is referred to as a “third-party claimant”. In contrast, a first-party claim is a claim by a claimant against the claimant's own insurance policy.

In the described examples, the accident involves two persons and one or more vehicles. One of the persons is the third-party claimant. The other person is an insured party. The third-party claimant files a claim against the insurance policy of the insured party. In a vehicle accident, the third-party claimant and the insured party may occupy the same vehicle or different vehicles. The third-party claimant may be insured by the same insurer as the insured party, but under a different policy. The third-party claimant may be insured by a different insurer as the insured party, or may be uninsured.

Referring again to FIG. 2, the process 200 may continue when the injured third-party (3P) claimant files a claim against the insurer of the first party for damages, at 204. For example, referring again to FIG. 1, the claimant 112 may employ client device 122 to file the claim in the insurer system 124. Of course, the claimant may employ other methods to file the claim. The claim may include one or more medical bills, which may be electronic medical bills, which may be stored in the databases 106.

Referring to FIG. 2, the process 200 may continue with the claims adjuster for the insurer agreeing to settle with the 3P claimant, at 206. For example, referring again to FIG. 1, the claims adjuster 114 may settle the claim by agreeing to pay a specific amount of monetary damages to a provider that has provided medical services to the claimant.

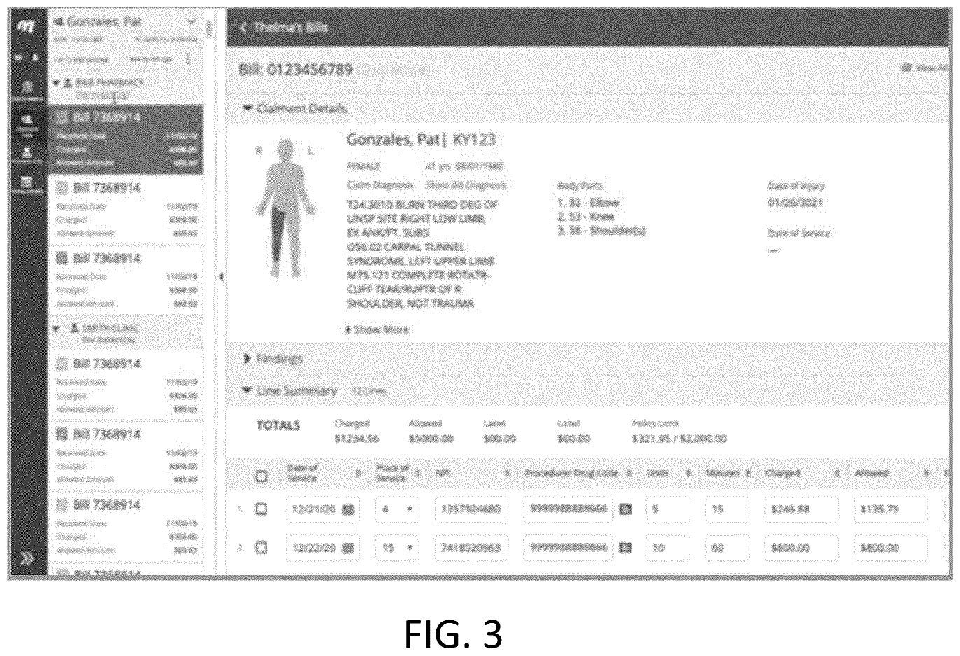

Referring again to FIG. 2, upon settling the claim, the process 200 may continue with the insurer, claimant, or provider sending an electronic medical bill to the 3P Liability Management Platform, at 208. For example, referring again to FIG. 1, the insurer system 124 may send the electronic medical bill to 3P Liability Management Platform 102. FIG. 3 illustrates an example electronic medical bill as presented in a user interface of the 3P Liability Management Platform 102.

Referring again to FIG. 2, the process 200 may include the 3P Liability Management Platform processing the electronic medical bill, at 210, for example as described in detail below.

After adjustment, the process 200 may include the 3P Liability Management Platform sending the adjusted bill to the insurer system, at 212. The insurer may then pay the provider, at 214. In some embodiments, the 3P Liability Management Platform 102 may generate invoices for the insurer. The invoices may be unique for each 3P claimant.

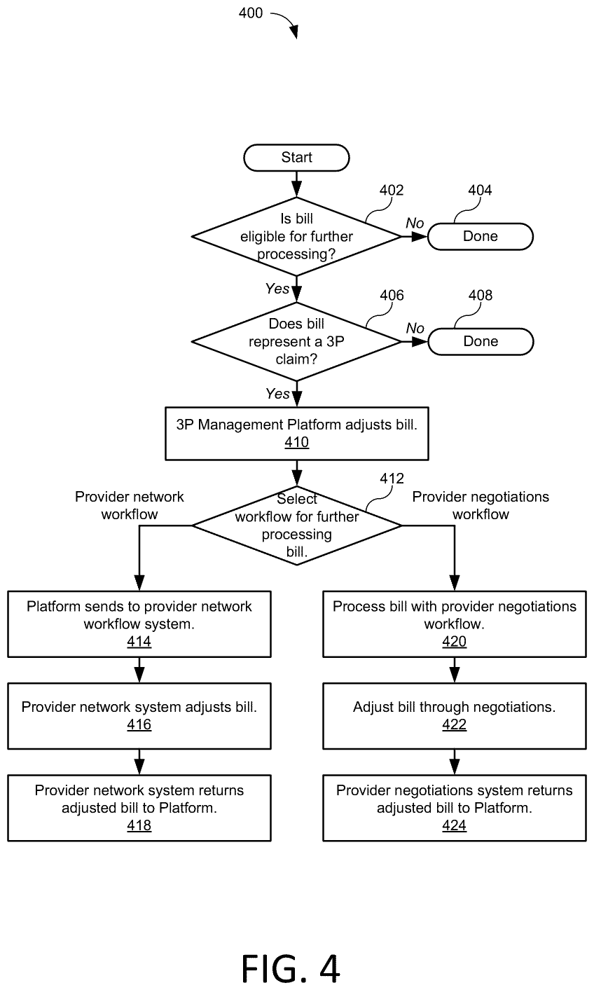

FIG. 4 illustrates a process 400 for third-party bill adjustment including integration with provider networks and provider negotiations systems according to some embodiments of the disclosed technology. Portions of the process 400 may be performed, for example, by the 3P Management Platform 102 of FIG. 1. The process 400 may correspond to step 210 of the process 200 of FIG. 2.

Referring to FIG. 4, upon receiving an electronic medical bill, the 3P Liability Management Platform 102 may determine whether the electronic medical bill is eligible for further processing, at 402. This determination may be made by the rules engine(s) 110 by executing one or more business rules established by the insurer. For example, a rule may specify an electronic medical bill is not eligible for processing when the 3P claimant is represented by an attorney. In this example, when the 3P claimant is represented by an attorney, the process 400 may end, at 404.

In some embodiments, the 3P Liability Management Platform 102 may determine whether the electronic medical bill represents a third-party claim, at 406. For example, whether the electronic medical bill represents a third-party claim may be determined according to the criteria described above. If the electronic medical bill does not represent a third-party claim, the process 400 may end, at 408, and the electronic medical bill may be managed according to other processes. If the electronic medical bill does represent a third-party claim, the process 400 may continue.

Referring again to FIG. 4, the process 400 may include adjusting the electronic medical bill, at 410. For example, referring again to FIG. 1, the 3P Liability Management Platform 102 may adjust the electronic medical bill. Adjusting the electronic medical bill may include executing one or more rules established by the insurer. In the example of FIG. 1, the 3P Liability Management Platform 102 may retrieve the rules from the databases 106 for execution by one or more of the rules engines 110. The rules engines 110 may employ one or more trained machine learning models, for example as described below.

Referring again to FIG. 4, the process 400 may include the 3P Liability Management Platform selecting a workflow for further processing of the electronic medical bill, at 412. For example, the Platform may select a provider network workflow. The provider network workflow may be a largely or completely automated process, and may be based on a previously-negotiated contract establishing agreed-upon network rates. The provider network workflow usually returns results within one business day.

Referring to FIG. 1, as part of the provider network workflow, the 3P Liability Management Platform 102 may send the electronic medical bill to the provider network system 126, at 414. In response, the provider network system 126 may adjust the electronic medical bill, at 416, and may return the adjusted electronic medical bill to the 3P Liability Management Platform 102, at 418. Processing may continue at step 212 of the process 200 of FIG. 2.

As another example, the Platform may select a provider negotiations workflow, at 420. The provider negotiations workflow may be a largely or completely manual process. The provider negotiations workflow includes establishing contact with a provider identified in the electronic medical bill, confirming information in the electronic medical bill, and agreeing to a discounted payment amount in exchange for prompt payment. The provider network workflow usually returns results within 7-10 business days.

Referring to FIG. 1, as part of the provider negotiations workflow, the 3P Liability Management Platform 102 may send the electronic medical bill to a provider device 128 operated by a provider billing representative 118, at 420. The 3P Liability Management Platform 102 may negotiate reductions in the billing amounts in the electronic medical bill with the provider by communicating with the provider billing representative 118 via the provider device 128, at 422. The provider device 128 may return the adjusted electronic medical bill to the 3P Liability Management Platform 102, at 424. Processing may continue at step 212 of the process 200 of FIG. 2.

The selection of workflow for further processing of the electronic medical bill may involve consideration of a number of decisioning factors. By way of non-limiting example, the decisioning factors may include the dollar value of the charges in the electronic medical bill, insurance policy coverage and/or penetration of the third-party claimant, cost containment, expected turnaround time for processing the electronic medical bill, and similar factors. For example, the process may favor the provider network workflow for an electronic medical bill having a low dollar value, while favoring the provider negotiations workflow an electronic medical bill having a high dollar value.

In some embodiments, a group of bills may be routed collectively. For example, the process may favor the provider negotiations workflow for a large group of electronic medical bills having individual low dollar values but a high total dollar value.

In some embodiments, the decisioning factors may include historic rates of success in the provider negotiations workflow for the type of electronic medical bill under consideration. In these embodiments, the process may favor the provider negotiations workflow for an electronic medical bill having a type historically associated with high rates of success in that workflow.

In some embodiments, the 3P Liability Management Platform 102 may interface with an external system that provides policy information to take into account remaining policy limits. The policy limits may include deductibles, maximum expenses over a period, and similar limits. For example, if a policy limit is near exhaustion, the electronic medical bill may be routed directly to the provider network system without negotiations. In some embodiments, the 3P Liability Management Platform 102 may use a predictive analytic model that provides the probability that policy limits will be exhausted, and allows a workflow routing decision based on that probability. The predictive analytic model may employ one or more trained machine learning models, for example as described below.

In some embodiments, the 3P Liability Management Platform 102 may capture collateral source information to confirm prior payments, identify sources of the payments, and determine total amounts paid, and may employ that information in an analysis of savings related to the electronic medical bills. For example, the collateral source information may reflect prior payments made to the claimant or provider network.

In some embodiments, the workflow selection process may include a scoring process. Specifically, an electronic medical bill may be scored according to one or more decisioning factors. For example, an individual electronic medical bill with a low dollar rate may receive a high score, where high scores favor selection of the provider network flow. The scores for an electronic medical bill may be summed and compared to one or more thresholds. With a single threshold, electronic medical bills with scores above the threshold may be routed to the provider network workflow while electronic medical bills with scores below the threshold may be routed to the provider negotiations workflow.

Some embodiments may employ multiple thresholds. In these embodiments, electronic medical bills with scores above a high threshold may be routed to the provider network workflow while electronic medical bills with scores below a low threshold may be routed to the provider negotiations workflow. Electronic medical bills with scores between the high and low thresholds may be flagged for human review and routing.

In some embodiments, the scoring system may weight each decisioning factor. For example, decisioning factors concerning costs may be weighted more heavily than decisioning factors that do not. In these embodiments, the weighted scores are summed and compared to one or more thresholds, for example as described above.

In some embodiments, the disclosed technologies may include the use of one or more trained machine learning models at one or more points in the described processes. Any machine learning models may be used. For example, the machine learning models and techniques may include classifiers, decision trees, neural networks, gradient boosting, and similar machine learning models and techniques. For example, a neural network may be trained and applied to receive an input electronic medical bill and generate a corresponding workflow for routing the bill.

The neural network may include a feature extraction layer that extracts features from the input data, e.g., a medical bill. In some embodiments, this process may be performed after input data preprocessing. The preprocessing may include input data transformation. The input data transformation may include converting different file types (e.g., image format, word format, etc.) into a unified digital format (e.g., pdf file). The preprocessing may include data extraction. The data extraction may include extracting useful information, for example using optical character recognition (OCR) and natural language processing (NLP) techniques.

The feature extraction in the feature extraction layer may be performed against the extracted data. Examples of features for extraction could include the total cost, itemized charges, diagnosis codes, clinical concepts, or any other relevant information present in the bills. The selection of the features for extraction may also be determined by learning importance scores for the candidate features using a tree-based machine learning model.

For example, the tree-based machine learning model for feature selection may use Random Forests or Gradient Boosting. The model includes an ensemble of decision trees that collectively make predictions. To begin, the tree-based model may be trained on a labeled dataset. The dataset may include historical medical bills with actual workflows used for subsequent routing. The actual workflows may be used as the ground truth labels for training purposes.

As the tree-based machine learning model learns to make predictions, it recursively splits the data (historical medical bills) based on different features, constructing a tree structure that captures patterns in the data. The goal of the training is to make the predictions as close to the ground truth labels as possible. One of the advantages of tree-based models is that they can generate feature importance scores for each input feature. These scores reflect the relative importance of each feature in contributing to the model's predictive power. A higher importance score indicates that a feature has a greater influence on the model's decision-making process.

In some embodiments, Gini importance metric may be used for feature importance in the tree-based model. Gini importance quantifies the total reduction in the Gini impurity achieved by each feature across all the trees in the ensemble. Features that lead to a substantial decrease in impurity when used for splitting the data are assigned higher importance scores.

Once the tree-based model is trained, the feature importance scores may be extracted. By sorting the features in descending order based on their scores, a ranked list of features may be obtained. This ranking enables prioritizing the features that have the most impact on the model's decision-making process.

Based on the feature ranking, the top features may be extracted from an incoming medical bill and fed into the neural network to predict whether a provider network workflow or a provider negotiations workflow should be adopted.

The neural network may include an output layer that provides output data based on the input data. For example, the output layer of a classifier may use a sigmoid activation function that outputs a probability value between 0 and 1 for each class.

For example, the routing decision process described above for the 3P Liability Management Platform 102 may be implemented using a trained machine learning model. The model may be trained using training data that reflect historic decisioning factors and corresponding workflow routing decisions. In some embodiments, the training data may include scores and weights of the decisioning factors, as well as thresholds employed with the scoring.

During inference operation, an electronic medical bill may be provided as inference input data to a trained machine learning model. An input layer of the model may extract one or more decisioning factors as input data from the electronic medical bill. Responsive to the inference input, an output layer of the model may provide output representing a probability for each workflow.

Some embodiments include training the machine learning models. The training may be supervised, unsupervised, or a combination thereof, and may continue between operations for the lifetime of the system. The training may include creating a training set that includes the input parameters and corresponding assessments described above.

The training may include one or more second stages. This retraining may be performed periodically and/or on the occurrence of one or more trigger conditions. The trigger conditions may include an evaluation metric falling below a predefined metric. A second stage may follow the training and use of the trained machine learning models, and may include creating a second training set, and training the trained machine learning models using the second training set. The second training set may include the inputs applied to the machine learning models, and the corresponding outputs generated by the machine learning models, during actual use of the machine learning models. The second training set may include evolving underlying data.

The second training stage may include identifying erroneous assessments generated by the machine learning model, and adding the identified erroneous assessments to the second training set. Creating the second training set may also include adding the inputs corresponding to the identified erroneous assessments to the second training set.

For example, the training may include supervised learning with labeled training data (e.g., historical inference input may be labeled with “automatic” or “manual” for training purposes). The training may be performed iteratively. The training may include techniques such as forward propagation, loss function, backpropagation for calculating gradients of the loss, and updating weights for each input.

The training may include a stage to initialize the model. This stage may include initializing parameters of the model, including weights and biases, and may be performed randomly or using predefined values. The initialization process may be customized to suit the type of model.

The training may include a forward propagation stage. This stage may include a forward pass through the model with a batch of training data. The input data may be multiplied by the weights, and biases may be added at each layer of the model. Activation functions may be applied to introduce non-linearity and capture complex relationships.

The training may include a stage to calculate loss. This stage may include computing a loss function that is appropriate for binary classification, such as binary cross-entropy or logistic loss. The loss function may measure the difference between the predicted output and the actual binary labels.

The training may include a backpropagation stage. Backpropagation involves propagating error backward through the network and applying the chain rule of derivatives to calculate gradients efficiently. This stage may include calculating gradients of the loss with respect to the model's parameters. The gradients may measure the sensitivity of the loss function to changes in each parameter.

The training may include a stage to update weights of the model. The gradients may be used to update the model's weights and biases, aiming to minimize the loss function. The update may be performed using an optimization algorithm, such as stochastic gradient descent (SGD) or its variants (e.g., Adam, RMSprop). The weights may be adjusted by taking a step in the opposite direction of the gradients, scaled by a learning rate.

The training may iterate. The training process may include multiple iterations or epochs until convergence is reached. In each iteration, a new batch of training data may be fed through the model, and the weights adjusted based on the gradients calculated from the loss.

The training may include a model evaluation stage. Here, the model's performance may be evaluated using a separate validation or test dataset. The evaluation may include monitoring metrics such as accuracy, precision, recall, and mean squared error to assess the model's generalization and identify possible overfitting.

The training may include stages to repeat and fine-tune the model. These stages may include adjusting hyperparameters (e.g., learning rate, regularization) based on the evaluation results and iterating further to improve the model's performance. The training can continue until convergence, a maximum number of iterations, or a predefined stopping criterion.

The described technology provides, among other things, features that may be applied to third-party liability exposures, and especially to the combination of provider networks and direct provider negotiations for third-party claims. While described as an end to end solution, alternate implementations may be employed that utilize one or more of the described components separately or based strictly on existing first party workflows.

The described technology provides several advantages over conventional solutions. The described technology provides an expansion of cost containment solutions to utilize provider networks to improve accuracy for third-party bodily injury billing when a direct provider payment can be secured. It also offers additional coverage opportunities in conjunction with provider negotiations service offerings thereby helping insurance carriers lower claim costs, provide more efficient handling, expand the coverage of cost containment solutions, and ensure the security of final provider payment.

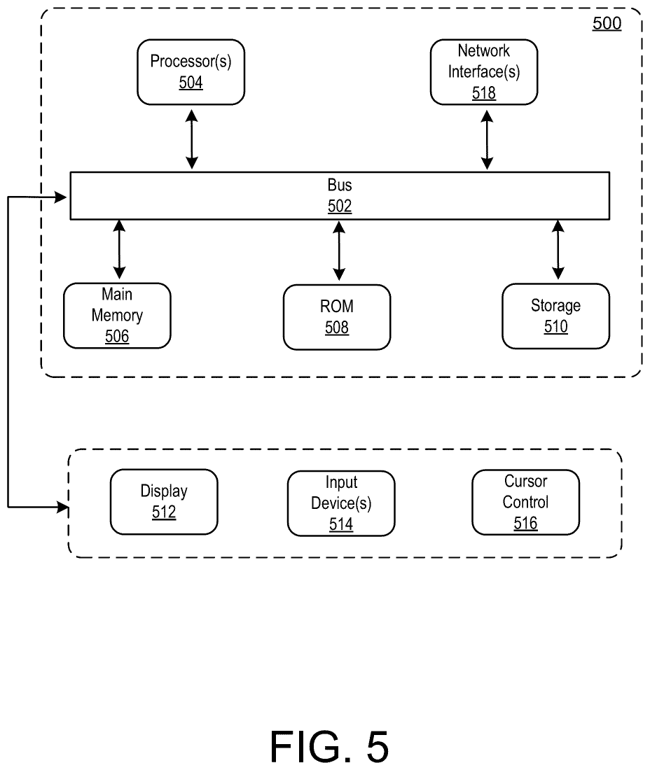

FIG. 5 depicts a block diagram of an example computer system 500 in which embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic electronic medical embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or a WAN component to communicate with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

1. A management platform for adjusting one or more electronic medical bills for a claimant injured in an accident, comprising:
one or more hardware processors; and
one or more non-transitory machine-readable storage media encoded with instructions executable by the one or more hardware processors to perform operations comprising:
receiving, from an insurer system of an insurer, an electronic medical bill representing medical services provided by a provider;
generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow,
responsive to generating a decision representing the provider network workflow:
routing the electronic medical bill to a provider network system, wherein the provider network system adjusts the electronic medical bill by adjusting one or more payment amounts in the electronic medical bill according to agreed-upon network rates,
receiving, from the provider network system, the adjusted electronic medical bill, and
transmitting the adjusted electronic medical bill to the insurer system.

2. The management platform of claim 1, the operations further comprising, responsive to generating a decision representing the provider negotiations workflow:
routing the electronic medical bill to a provider negotiations process, wherein the provider negotiations process adjusts the electronic medical bill by adjusting one or more payment amounts in the electronic medical bill;
receiving, from the provider negotiations system, the adjusted electronic medical bill; and
transmitting the adjusted electronic medical bill to the insurer system.

3. The management platform of claim 1, the operations further comprising, prior to generating a decision representing a workflow:
retrieving, from a rules database, one or more rules established by the insurer; and
adjusting the electronic medical bill according to the one or more rules.

4. The management platform of claim 1, wherein the plurality of decisioning factors comprise at least one of:
a dollar value of charges in the electronic medical bill;
insurance policy coverage of the claimant;
expected turnaround time for processing the electronic medical bill; and
historical rates of success in provider negotiations for a type of electronic medical bill.

5. The management platform of claim 1, the operations further comprising:
obtaining a training data set comprising the historical electronic medical bills and corresponding historical decisions; and
training the machine learning model using the training data set.

6. The management platform of claim 5, the operations further comprising:
generating the training data set.

7. The management platform of claim 1, the operations further comprising:
determining whether the electronic medical bill is eligible for further processing; and
generating a decision representing a workflow only responsive to determining the electronic medical bill is eligible for further processing.

8. One or more non-transitory machine-readable storage media encoded with instructions executable by the one or more hardware processors to perform operations for adjusting one or more electronic medical bills for a claimant injured in an accident, the operations comprising:
receiving, from an insurer system of an insurer, an electronic medical bill representing medical services provided by a provider;
generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow,
responsive to generating a decision representing the provider network workflow:
routing the electronic medical bill to a provider network system, wherein the provider network system adjusts the electronic medical bill by adjusting one or more payment amounts in the electronic medical bill according to agreed-upon network rates,
receiving, from the provider network system, the adjusted electronic medical bill, and
transmitting the adjusted electronic medical bill to the insurer system.

9. The one or more non-transitory machine-readable storage media of claim 8, the operations further comprising, responsive to generating a decision representing the provider negotiations workflow:
routing the electronic medical bill to a provider negotiations process, wherein the provider negotiations process adjusts the electronic medical bill by adjusting one or more payment amounts in the electronic medical bill;
receiving, from the provider negotiations system, the adjusted electronic medical bill; and
transmitting the adjusted electronic medical bill to the insurer system.

10. The one or more non-transitory machine-readable storage media of claim 8, the operations further comprising, prior to generating a decision representing a workflow:
retrieving, from a rules database, one or more rules established by the insurer; and
adjusting the electronic medical bill according to the one or more rules.

11. The one or more non-transitory machine-readable storage media of claim 8, wherein the plurality of decisioning factors comprise at least one of:
a dollar value of charges in the electronic medical bill;
insurance policy coverage of the claimant;
expected turnaround time for processing the electronic medical bill; and
historical rates of success in provider negotiations for a type of electronic medical bill.

12. The one or more non-transitory machine-readable storage media of claim 8, the operations further comprising:
obtaining a training data set comprising the historical electronic medical bills and corresponding historical decisions; and
training the machine learning model using the training data set.

13. The one or more non-transitory machine-readable storage media of claim 12, the operations further comprising:
generating the training data set.

14. The one or more non-transitory machine-readable storage media of claim 8, the operations further comprising:
determining whether the electronic medical bill is eligible for further processing; and
generating a decision representing a workflow only responsive to determining the electronic medical bill is eligible for further processing.

15. A computer-implemented method for adjusting one or more electronic medical bills for a claimant injured in an accident, the operations comprising:
receiving, from an insurer system of an insurer, an electronic medical bill representing medical services provided by a provider;
generating a decision representing a workflow selected from a plurality of the workflows based on at least one of a plurality of decisioning factors describing the electronic medical bill by providing the electronic medical bill as an inference input to a trained machine learning model, wherein responsive to the inference input the trained machine learning model generates the decision representing a workflow, wherein the trained machine learning model has been trained with historical electronic medical bills and corresponding historical decisions, the workflows including a provider network workflow and a provider negotiations workflow,
responsive to generating a decision representing the provider network workflow:
routing the electronic medical bill to a provider network system, wherein the provider network system adjusts the electronic medical bill by adjusting one or more payment amounts in the electronic medical bill according to agreed-upon network rates,
receiving, from the provider network system, the adjusted electronic medical bill, and
transmitting the adjusted electronic medical bill to the insurer system.

16. The computer-implemented method of claim 15, the operations further comprising, responsive to generating a decision representing the provider negotiations workflow:
routing the electronic medical bill to a provider negotiations process, wherein the provider negotiations process adjusts the electronic medical bill by adjusting one or more payment amounts in the electronic medical bill;
receiving, from the provider negotiations system, the adjusted electronic medical bill; and
transmitting the adjusted electronic medical bill to the insurer system.

17. The computer-implemented method of claim 15, the operations further comprising, prior to generating a decision representing a workflow:
retrieving, from a rules database, one or more rules established by the insurer; and
adjusting the electronic medical bill according to the one or more rules.

18. The computer-implemented method of claim 15, wherein the plurality of decisioning factors comprise at least one of:
a dollar value of charges in the electronic medical bill;
insurance policy coverage of the claimant;
expected turnaround time for processing the electronic medical bill; and
historical rates of success in provider negotiations for a type of electronic medical bill.

19. The computer-implemented method of claim 15, the operations further comprising:
obtaining a training data set comprising the historical electronic medical bills and corresponding historical decisions; and
training the machine learning model using the training data set.

20. The computer-implemented method of claim 19, the operations further comprising:
generating the training data set.
